(19) United States
(12) Patent Application Publication
(10) Pub. No.: US 2010/0127487 A1
(43) Pub. Date: May 27, 2010

(54) SEWING STRUCTURE OF FACING SHEET MEMBER FOR COVERING VEHICLE SEAT, METHOD FOR PRODUCING THE SAME, AND AIR BAG STRUCTURE FOR VEHICLE SEAT

(75) Inventors: Tomoko KAMO, Toyota-shi (JP); Kunio NISHIYAMA, Okazaki-shi (JP)

Correspondence Address: GREENBLUM & BERNSTEIN, P.L.C., 1950 ROLAND CLARKE PLACE, RESTON, VA, 20191, US

(73) Assignee: TOYOTA BOSHOKU KABUSHIKI KAISHA, Aichi-ken (JP)

(21) Appl. No.: 12/621,778

(22) Filed: Nov. 19, 2009

(30) Foreign Application Priority Data
Nov. 25, 2008 (JP) 2008-299527

(51) Int. Cl. B60R 21/207; D04H 1/00; B68G 7/05

(52) U.S. Cl. 280/743.1; 112/402; 29/91.1

(57) ABSTRACT

An aspect of the present invention provides a sewing structure of a facing sheet member for covering a vehicle seat. The facing sheet member is formed by sewing a plurality of facing sheet pieces together at respective end parts thereof. Each of the facing sheet pieces includes a surface member and a pad member laminated on the surface member. In the end part of each of the facing sheet pieces, at least a part of the pad member is removed or the pad member is not laminated on the surface member. The plurality of facing sheet pieces are sewed together using the surface members at the end parts thereof.

### BACKGROUND OF THE INVENTION

1. Field of the Invention

The present invention relates to a sewing structure of facing sheet member for covering a vehicle seat, a method for producing the sewing structure and an air bag structure for a vehicle seat.

2. Description of the Related Art

A facing sheet member of a vehicle seat is for covering a pad part which forms an outer shape of a seat. Typically, the facing sheet member includes a surface member formed of leather and provided at a sitting side of the seat, a pad member (sheet-like form) bonded to a back face of the surface member, and a coating layer formed on a surface of the surface member.

Since the facing sheet member is for constituting a surface of the seat, the facing sheet member is likely to be subjected to friction and pressure due to motions of a passenger when he gets on or off the vehicle (pressure of the passenger). Particularly, in case where there is a protruded part in the facing sheet member, the pressure of the passenger is concentrated on this protruded part, and the facing sheet member is partially damaged or the coating layer on this part is peeled off.

In the meantime, the facing sheet member for the vehicle seat is typically formed by sewing a plurality of facing sheet pieces together into a shape of a bag. In those parts where the facing sheet pieces are sewn together, end parts of the facing sheet pieces are turned back inwardly (turned outside in) and sewn to each other. Therefore, these parts have a thickness twice as large as the other part of the facing sheet member, and are likely to become protruded parts.

In view of the above, JP-A-2007-289284 describes a structure for reducing the thickness of the end parts of the facing sheet pieces by providing overcasting along the end parts, thereby to reduce protrusion of the sewn parts as much as possible.

However, in JP-A-2007-289284, a work for providing the overcasting on the facing sheet pieces is troublesome more than expected, and the sewing work of the facing sheet member takes time.

It is of course possible to apply nonwoven fabric or the like to the sewn parts of the facing sheet pieces. That is, by attaching the nonwoven fabric to back faces of the facing sheet pieces (providing slidability), slidability with respect to the pad member is enhanced, whereby the pressure of the passenger is dispersed and reduced. However, this structure incurs an increase in number of components of the facing sheet member, and cannot be adopted in some cases, while taking production cost for the facing sheet member into consideration.

### SUMMARY OF THE INVENTION

Accordingly, it is an aspect of the present invention to provide sewing structure of facing sheet member for covering a vehicle seat which reduces a thickness of sewn parts of a facing sheet member with a simple structure, a method for producing the sewing structure of the facing sheet member, and an air bag structure for a vehicle seat.

According to an exemplary embodiment of the present invention, there is provided a sewing structure of a facing sheet member for covering a vehicle seat, the facing sheet member being formed by sewing a plurality of facing sheet pieces together at respective end parts thereof, each of the facing sheet pieces comprising a surface member and a pad member laminated on the surface member. In the end part of each of the facing sheet pieces, at least a part of the pad member is removed or the pad member is not laminated on the surface member. The plurality of facing sheet pieces are sewed together using the surface members at the end parts thereof.

According to another exemplary embodiment of the present invention, there is provided a method for producing a sewing structure of a facing sheet member for covering a vehicle seat, the facing sheet member including a plurality of facing sheet pieces, each having a surface member and a pad member laminated on the surface member, the method comprising: removing at least a part of the pad member laminated on the surface member at an end part of each of the plurality of facing sheet pieces; and sewing the surface members of respective facing sheet pieces at the end parts thereof, in which the at least the part of the pad member is removed, to combine the respective facing sheet pieces.

According to another exemplary embodiment of the present invention, there is provided an air bag structure for a vehicle seat, the air bag structure comprising: an air bag provided in the vehicle seat; and a facing sheet member covering the vehicle seat. The facing sheet member being formed by sewing a plurality of sheet pieces together at respective end parts thereof, each of the facing sheet pieces comprising a surface member and a pad member laminated on the surface member. In the end part of each of the facing sheet pieces, at least a part of the pad member is removed or the pad member is not laminated on the surface member. The plurality of facing sheet pieces are sewed together using the surface members at the end parts thereof.

According to the above configuration, it is possible to reduce the thickness of the sewn parts of the facing sheet member by employing the more simple structure.

### BRIEF DESCRIPTION OF THE DRAWINGS

In the accompanying drawings:

FIG. 1 is a perspective view of a vehicle seat.

FIG. 2 is a vertical sectional view taken along a line II-II in FIG. 1;

FIG. 3 is a vertical sectional view of a facing sheet member according to Embodiment 1; and

FIG. 4 is a vertical sectional view of a facing sheet member according to Embodiment 2.

### DETAILED DESCRIPTION

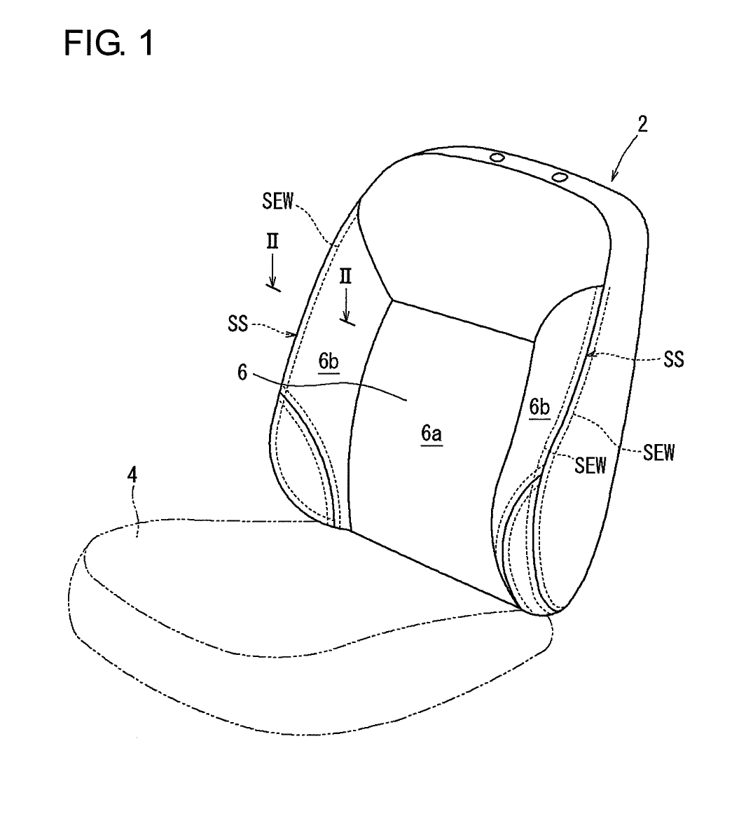

Hereinafter, exemplary embodiments of the present invention will be described with reference to FIGS. 1 to 4.

As shown in FIG. 1, a vehicle seat 2 includes a seat cushion 4 and a seat back 6. The seat back 6 has a concave part at a center thereof (a sitting part 6a) and convex parts at both sides thereof (both side parts 6b, 6b) for improving sitting comfort of a passenger.

The both side parts 6b, 6b of the seat back 6 have sewn parts SS where facing sheet pieces (described later) are sewn together. A sewing structure of a facing sheet member 6S according to exemplary embodiments will be described while taking this seat back 6 as an example.

### Embodiment 1

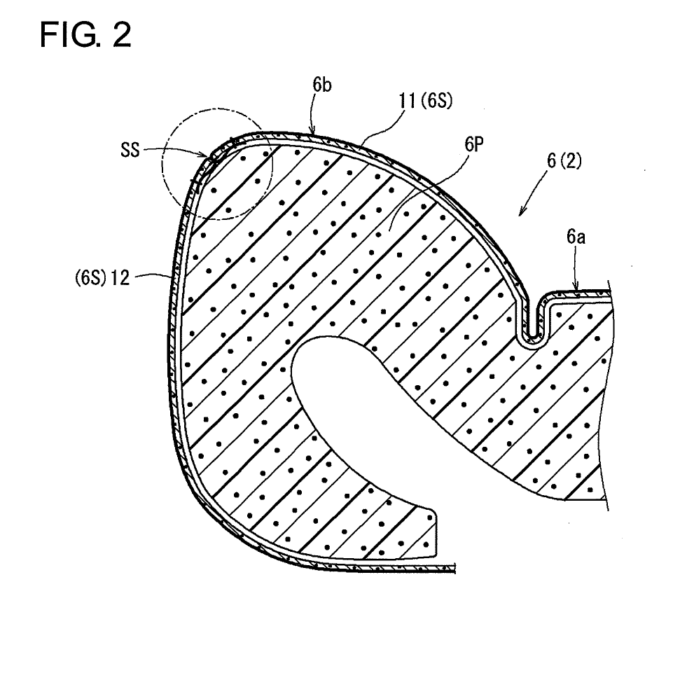

Referring to FIG. 2, the seat back 6 has a pad part 6P which forms an outer shape of the seat, and a facing sheet member 6S.

This facing sheet member 6S is formed by sewing a plurality of facing sheet pieces such as a first facing sheet piece 11 and a second facing sheet piece 12 (described later) together into a shape of a bag. In the sewn parts SS in the facing sheet member 6S, an end part E of each facing sheet piece is inwardly turned back (turned outside in) as described later, and are likely to become protruded parts.

In this exemplary embodiment, as shown in FIG. 2, when the pad part 6P is covered with the facing sheet member 6S, the sewn parts SS extending in a vertical direction of the seat are formed in the side parts 6b of the seat back 6, while considering an appearance of the seat and the like.

However, the side parts 6b of the seat back 6 (in a convex shape) are likely to be contacted with the passenger, when he gets on or off the vehicle, and therefore, it is advantageous that the facing sheet member is smooth and flat, that is, without protruded part on which the pressure is concentrated. Accordingly, in this exemplary embodiment, by employing the below-described sewing structure of the facing sheet member 6S, the thickness of the sewn parts SS is reduced.

(Facing Sheet Piece)

In this exemplary embodiment, the side part 6b of the seat back 6 includes the first facing sheet piece 11 forming a front face of the seat and the second facing sheet piece 12 forming a side face of the seat. Each of the facing sheet pieces 11, 12 includes a surface member 22 and a pad member 24. These members 22, 24 are integrated (combined) by, for example, laminating process into double structure. That is, the pad member 24 is laminated on the surface member 22.

This surface member 22 is a member constituting a sitting side of the facing sheet member 6S, and is formed of material having adequate elasticity and strength. For example, the surface member may be natural leather or artificial leather. Additionally, a coating layer of dye or pigment (not shown) is formed on the sitting side of the surface member 22.

The pad member 24 (sheet-like form) is preferably formed of softer material than the pad part 6P, and may be formed of soft urethane foam, for example.

While considering sitting comfort of the facing sheet member 6S, this pad member 24 has certain elasticity and has a thickness equal to or larger than the thickness of the surface member 22. For this reason, if the pad member 24 is turned back outside in as it is, the thickness of the facing sheet member 6S at the end parts becomes relatively larger due to the pad member 24 which is inwardly turned back.

(Sewing Structure)

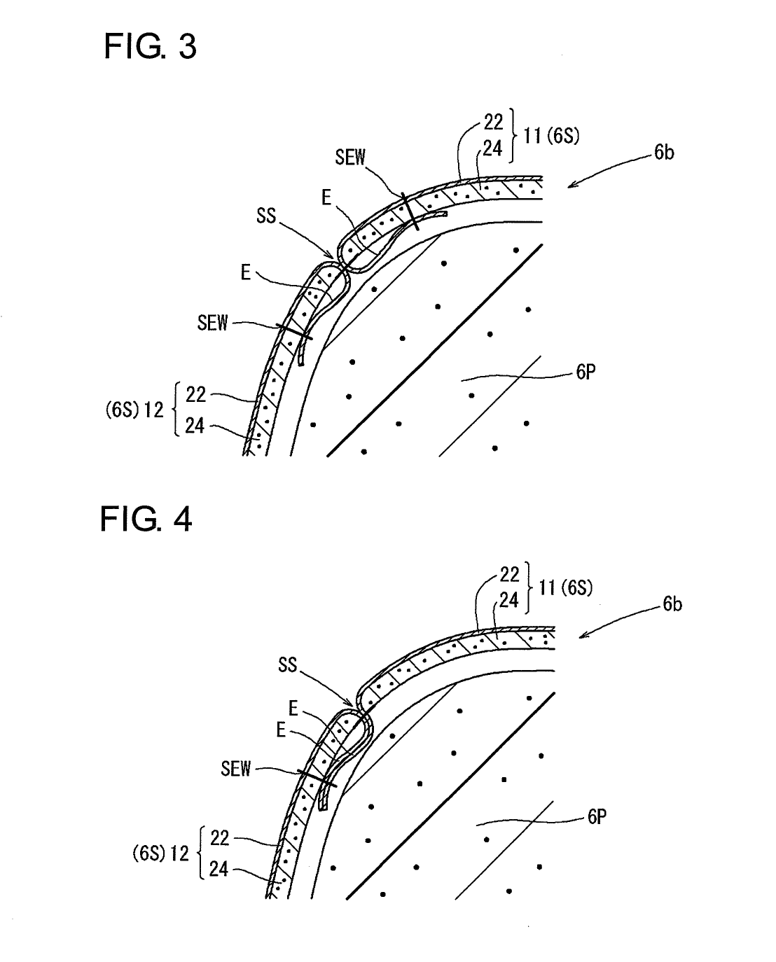

In view of the above, in this exemplary embodiment, the facing sheet pieces 11, 12 are sewn to each other by the surface members 22 at the respective end parts E after the pad members 24 are removed from the end parts E of the facing sheet pieces 11, 12. Specifically, referring to FIG. 3, the pad members 24 are respectively removed from the end part E of the first facing sheet piece 11 and the end part E of the second facing sheet piece 12, whereby the respective end parts E of the facing sheet pieces 11, 12 have only the surface members 22. A thickness of the end part E is reduced substantially to a half by removing the pad member 24. The facing sheet pieces 11, 12 are sewn to each other using the surface members 22 of the respective end parts E, and thereafter, only the surface members 22 of the respective end parts E are inwardly turned back to be sewn to the back faces of the respective facing sheet pieces.

In this exemplary embodiment, as described above, the thickness of the sewn part SS which is formed in the side part 6b of the seat can be reduced with a relatively simple configuration of removing the pad members 24 from the end parts E of the facing sheet pieces 11, 12. Accordingly, it is possible to prevent or reduce concentration of the pressure on the passenger to the sewn part SS.

Moreover, in this exemplary embodiment, the end parts E of the facing sheet pieces are sewed outside in, respectively. In other words, the end parts of the facing sheet pieces are stitched to the facing sheet pieces, respectively, while the end parts are turned. Accordingly, a pair of sewing lines SEW, SEW (double stitch) are formed on the facing sheet member 6S. Accordingly, the appearance of the vehicle seat 2 can be enhanced.

In the meantime, an air bag (not shown) for protecting the passenger at occasion of collision of the vehicle may be provided in the side part 6b of the seat back 6. This air bag is disposed inside the pad part 6P of the vehicle seat, and expanded sideways of the seat by breaking the facing sheet member 6S with a shock at collision of the vehicle. It is noted that as the air bag, an air bag described in, for example, JP-A-2007-145193 can be used.

Therefore, the sewn part SS in this exemplary embodiment is formed in a region covering the air bag. In this case, at occasion of collision of the vehicle, the air bag can be expanded by smoothly breaking the sewn part SS of the facing sheet member 6S (the sewn part SS where the surface members 22 are sewn to each other outside in).

### Embodiment 2

Since a basic structure in Embodiment 2 is substantially the same as a basic structure in Embodiment 1, those members which are common to both the embodiments will be denoted with the same reference numerals, and their detailed descriptions will be omitted.

In Embodiment 2, as shown in FIG. 4, a case where a single sewing line SEW (single stitch) is formed on the facing sheet member 6S will be described.

In this exemplary embodiment, the end part E of the second facing sheet piece 12 is inwardly turned back, and arranged on a back face of the second facing sheet piece 12. Then, the end part E of the first facing sheet piece 11 is arranged on the back face of the second facing sheet piece 12 in a state extended as it is (without being inwardly turned back). The end parts E of the two facing sheet pieces are overlapped and sewn to the back face of the second facing sheet piece 12, whereby a single sewing line SEW (single stitch) can be formed.

In this manner, according to this exemplary embodiment, design variation of the facing sheet member 6S is increased, and at the same time, connection between the two facing sheet pieces (11, 12) can be reinforced.

### Test Example

Hereinafter, exemplary embodiments will be further described below, referring to a test example, but the present invention is not limited to the test example.

### Example 1

In Example 1, the surface member 22 formed of natural leather and the pad member 24 formed of soft urethane foam were used (See FIG. 3). The surface member 22 and the pad member 24 had the same thickness. In addition, a coating layer by semi-aniline dying was formed on a front face of the surface member 22.

After the pad members 24 had been removed by 10±3 mm from the end parts E of the respective facing sheet pieces, the facing sheet pieces were sewn to each other using their terminal end parts E. Since the pad members 24 had been thus removed, the thickness of the end parts E was reduced to a half. Then, the end parts E of these facing sheet pieces were turned back outside in, and sewn to the back faces of the facing sheet pieces, respectively, by making a double stitch, thereby to produce the facing sheet member 6S in a shape of a bag. Then, the pad part 6P was covered with the facing sheet member 6S, and the sewn parts SS were formed on the seat back 6 (See FIG. 1).

### Comparative Example 1

In Comparative Example 1, in the same manner as Example 1, the surface member 22 formed of natural leather and the pad member 24 formed of soft urethane foam were used. The surface member 22 and the pad member 24 had the same thickness. In addition, a coating layer by semi-aniline dying was formed on a front face of the surface member 22.

The end parts E of the respective facing sheet pieces were sewn together without removing the pad members 24. Then, the end parts E of these facing sheet pieces were turned back outside in, and sewn to the back faces of the facing sheet pieces, respectively, by making a double stitch, thereby to produce the facing sheet member 6S in a shape of a bag. Then, the pad part 6P was covered with the facing sheet member 6S, and the sewn parts SS were formed on the seat back 6.

(Endurance Test)

The endurance of the facing sheet member 6S of Example 1 and Comparative Example 1 was measured by a test in which human movements such as up and down movement, forward and rearward movement, and twist movement were reproduced by a hip-shaped model.

Specifically, under the temperature of 20° C., the hip-shaped model having a sitting width of 39 cm was placed on the seat back 6 (sewn part SS), and load of 25 kg were applied to the hip-shaped model. In this state, the hip-shaped model was moved in up and down by 50 mm, in forward and rearward by 30 mm, and in twist by 15 degree repeatedly in this order, on the sewn part SS. Then, when the total number of this repetition reached 1000, 5000, and 10000, the damage of the facing sheet member 6S was observed. The same test was conducted to the facing sheet member 6s of Comparative Example 1

(Test Results and Observation)

In the facing sheet member 6S in Comparative example 1, abrasion has occurred when the total number of repletion has reached 1000 times.

It can be considered that the abrasion has occurred in the sewn part SS since the double stitch in the sewn part SS was hardened like a bead edge, and the coating layer on the surface of the facing sheet member 6S was worn out.

In contrast, in the facing sheet member 6S in Example 1, damage in the sewn part SS (crack, abrasion (whitened), wear) was not observed, even when the total number of repetition has exceeded 10000 times. From this result, it was proved that endurance of the facing sheet member 6S in Example 1 at getting on and off the seat was enhanced by reducing the thickness of the sewn part SS to a half, by more than ten times than in Comparative test 1.

While the present invention has been shown and described with reference to certain exemplary embodiments thereof, it will be understood by those skilled in the art that various changes in form and details may be made therein without departing from the spirit and scope of the invention as defined by the appended claims.

(1) In the exemplary embodiments, the structure for sewing the end parts E of the facing sheet pieces to the back faces of the facing sheet pieces (a case where the double stitch or the single stitch is formed) has been described. Different from this, it is also possible to leave the end parts E of the respective facing sheet pieces 11, 12 as they are, without sewing them to the back faces of the facing sheet pieces, after the facing sheet pieces have been sewn together using the surface members 22 of the respective end parts E to form the sewn part SS. That is, a structure without forming the sewing line SEW is also possible.

Moreover, different form the double stitch and the single stitch, out stitches of various types may be applied to the facing sheet member 6S.

(2) As a method of joining the surface member to the pad member, it is possible to employ various methods such as sewing, bonding and so on, different from the laminating process as described above.

(3) Although the facing sheet member 6S in a shape of a bag is shown as an example in the above exemplary embodiments, the shape of the facing sheet member 6S may be in various shapes according to the shape of the vehicle seat 2.

(4) The facing sheet member in the above-described exemplary embodiments may be formed by laminating another member (for example, a back substrate cloth) on the surface member 22 and the pad member 24. In this case, it would be preferable to remove the pad member and the other member from the facing sheet pieces at the end parts thereof.

(5) The sewn part SS may be formed not only in the side parts 6b, but also in the sitting part 6a and in other places of the seat back 6. Particularly, it is desired that the sewn part SS in Embodiment 1 may be provided at a position where an air bag is disposed.

Further, the sewing structure of the facing sheet member 6S according to the above-described exemplary embodiment can be applied to a seat structure of various types, such as the seat cushion 4, different from the seat back 6.

(6) Although the pad member 24 is entirely removed from the end parts E of the facing sheet pieces 11, 12 in the above exemplary embodiment, the pad member 24 may be not entirely removed from the end parts E of the facing sheet pieces 11, 12. In other words, at least a part of the pad member 24 may be removed from the end parts E of the facing sheet pieces 11, 12. Alternatively, in the end parts E of the facing sheet pieces 11, 12, the pad member 24 may not be provided on the surface member 22. In this case, each of the facing sheet pieces 11, 12 may be formed by laminating the pad member 24 shorter than the surface member 22 on the surface member 22.

What is claimed is:

1. A sewing structure of a facing sheet member for covering a vehicle seat, the facing sheet member being formed by sewing a plurality of facing sheet pieces together at respective end parts thereof, each of the facing sheet pieces comprising a surface member and a pad member laminated on the surface member,
wherein in the end part of each of the facing sheet pieces, at least a part of the pad member is removed or the pad member is not laminated on the surface member, and
wherein the plurality of facing sheet pieces are sewed together using the surface members at the end parts thereof.

2. The sewing structure according to claim 1,
wherein the end part of each of the facing sheet pieces is formed by removing the entire pad member laminated on the surface member.

3. The sewing structure according to claim 1,
wherein each of the facing sheet pieces is formed by laminating the pad member shorter than the surface member on the surface member, to form the end part thereof, in which the pad member is not laminated on the surface member.

4. The sewing structure according to claim 1,
wherein a thickness of the pad member is equal to or larger than that of the surface member.

5. The sewing structure according to claim 1,
wherein the end parts of the facing sheet pieces are sewed to the facing sheet pieces, respectively, while the end parts are turned.

6. The sewing structure according to claim 1,
wherein the end parts of the facing sheet pieces are sewed to one of the facing sheet pieces while the end parts are overlapped to the one of the facing sheet pieces.

7. A method for producing a sewing structure of a facing sheet member for covering a vehicle seat, the facing sheet member including a plurality of facing sheet pieces, each having a surface member and a pad member laminated on the surface member, the method comprising:
removing at least a part of the pad member laminated on the surface member at an end part of each of the plurality of facing sheet pieces; and
sewing the surface members of respective facing sheet pieces at the end parts thereof, in which the at least the part of the pad member is removed, to combine the respective facing sheet pieces.

8. An air bag structure for a vehicle seat, the air bag structure comprising:
an air bag provided in the vehicle seat; and
a facing sheet member covering the vehicle seat,
wherein the facing sheet member being formed by sewing a plurality of sheet pieces together at respective end parts thereof, each of the facing sheet pieces comprising a surface member and a pad member laminated on the surface member,
wherein in the end part of each of the facing sheet pieces, at least a part of the pad member is removed or the pad member is not laminated on the surface member, and
wherein the plurality of facing sheet pieces are sewed together using the surface members at the end parts thereof.

9. The air bag structure according to claim 8,
wherein the end parts of the facing sheet pieces are sewed to the facing sheet pieces, respectively, while the end parts are turned.
